(19) United States
(12) Patent Application Publication
(10) Pub. No.: US 2012/0239431 A1
(43) Pub. Date: Sep. 20, 2012

(54) MEDICAL-INFORMATION MANAGEMENT SYSTEM AND COMPUTER-READABLE MEDIUM

(75) Inventor: Naoki HAYASHI, Tokyo (JP)

(73) Assignee: KONICA MINOLTA MEDICAL & GRAPHIC, INC., Tokyo (JP)

(21) Appl. No.: 13/422,386

(22) Filed: Mar. 16, 2012

(30) Foreign Application Priority Data
Mar. 17, 2011 (JP) 2011-058787

(51) Int. Cl. G06Q 50/24

(52) U.S. Cl. 705/3

(57) ABSTRACT

A medical-information management system includes: an operation unit; a first storage unit that stores medical information; a display unit; and a control unit that determines whether an operation is performed through the operation unit, the operation including (a) acquiring the medical information from one of a second storage unit and a recording medium, (b) storing the acquired medical information in the first storage unit, and (c) displaying the medical information stored in the first storage unit on the display unit; and that grants an operator of the operation unit authority to delete the medical information, acquired in the operation, from the first storage unit when it is determined that the operation is performed.

### BACKGROUND OF THE INVENTION

1. Field of the Invention

The present invention relates to a medical-information management system and a computer-readable medium.

2. Description of Related Art

In the field of medicine, medical images of patients are digitalized. Such digitalization is achieved with various modalities, such as image generating devices, including computed radiography (CR) devices, computed tomography (CT) devices, magnetic resonance imaging (MRI) devices, and cassette readout devices. A data management server consolidates digitalized medical images together with patient information, examination information, and other information. Specifically, medical images and Digital Imaging and Communications in Medicine (DICOM) basic information (additional information), which conforms to the DICOM standard, are registered in databases of the data management server to be managed.

In recent years, the number of examinations conducted by acquiring multiple series of medical images with CT devices and MRI devices has increased. This results in a significant increase in the number of medical images and the amount of medical information, such as interpretation reports, associated with the medical images that are stored and managed in a data management server. Thus, large hospitals and even some middle to small hospitals use multiple servers.

In the case where the multiple servers manage medical information, such as medical images and interpretation reports of the medical images, Query/Retrieve Service Class User (hereinafter referred to as “Query/Retrieve process”), which is a service class conforming to the DICOM standard, is typically used to retrieve medical information from a specific server to another server. This service makes an inquiry from a specific server A to another server B which is managing the medical information to retrieve desired medical information from the server B. Using Query/Retrieve process enables medical information to be retrieved from the server A and to be displayed on a client terminal, even if the other server B is made by a different manufacturer or is a model different from that of the server A.

In order to display medical information from a second server on a client terminal by the Query/Retrieve process, a first server must acquire (register) the medical information retrieved from the second server. This is because various parameters for the medical information to be displayed and processed should be registered in specific locations in the first server, to appropriately display the medical information using the viewer function of the client terminal and to perform appropriate image processing.

Retrieving medical information from the second server into the first server every time, however, will lead to a shortage in storage capacity and marginalization of the use of multiple servers. Moreover, it is desirable to delete medical information retrieved for temporal reference, after referring to it.

However, the guideline for electronic storage states the obligation of storing retrieved medical information, such as medical images, for a predetermined amount of time. Thus, once medical information is registered in a server, it cannot be easily deleted. Furthermore, a user must be authorized to delete the medical information registered in a server. Usually, only an authorized administrator can delete medical information. Thus, to delete medical information from a first server after accessing the medical information in the second server via the first server, a troublesome process must be performed to grant temporal authority to a user by the administrator or to ask an authorized administrator to delete the medical information.

As a solution to such a problem, for example, Japanese Unexamined Patent Application Publication No. 2007-102615 describes a technique for storing access authorities, which define the access range of users, for combinations of filter conditions for image information and patient information, and allowed operations (readout, modification, deletion, etc.); and for determining whether access (operation) by a user is permitted on the basis of the stored access authority.

According to Japanese Unexamined Patent Application Publication No. 2007-102615, access authority can be flexibly granted to a user so that the user is authorized to, for example, delete medical images containing specific patient information and/or specific image information. Further, the process of changing authority is relatively easy.

However, the technique described in Japanese Unexamined Patent Application Publication No. 2007-102615 requires registration for changing authority. As described above, medical images retrieved from the second server or a recording medium and temporarily stored on the first server cannot be deleted unless the medical images contain image information and patient information matching the filter conditions.

### SUMMARY OF THE INVENTION

The present invention prevents the storage capacity of a server from being consumed by medical information that actually does not need to be stored in the server.

According to a first aspect of the present invention, there is provided a medical-information management system including: an operation unit; a first storage unit that stores medical information; a display unit; and a control unit that determines whether an operation is performed through the operation unit, the operation including (a) acquiring the medical information from one of a second storage unit and a recording medium, (b) storing the acquired medical information in the first storage unit, and (c) displaying the medical information stored in the first storage unit on the display unit; and that grants an operator of the operation unit authority to delete the medical information, acquired in the operation, from the first storage unit when it is determined that the operation is performed.

According to a second aspect of the present invention, there is provided a non-transitory computer-readable medium that stores a program to control a computer used for a medical-information management system, the system including an operation unit, a first storage unit that stores medical information, and a display unit; wherein the program controls the computer to function as a control unit that determines whether an operation is performed through the operation unit, the operation including (a) acquiring the medical information from one of a second storage unit and a recording medium, (b) storing the acquired medical information in the first storage unit, and (c) displaying the medical information stored in the first storage unit on the display unit; and that grants an operator of the operation unit authority to delete the medical information, acquired in the operation, from the first storage unit when it is determined that the operation is performed.

### BRIEF DESCRIPTION OF THE DRAWINGS

The above and other objects, advantages and features of the present invention will become more fully understood from the detailed description given hereinbelow and the appended drawings which are given byway of illustration only, and thus are not intended as a definition of the limits of the present invention, and wherein:

FIG. 1 illustrates the overall configuration of a medical-information management system according to an embodiment of the present invention;

FIG. 2 is a block diagram illustrating the functional configuration of a first server in FIG. 1;

FIG. 3 illustrates an example of data format of an authorization setting file stored in a storage unit in FIG. 2;

FIG. 4 illustrates an example of data format of a specific-operation authorization-expansion file stored in the storage unit in FIG. 2;

FIG. 5 is a block diagram illustrating the functional configuration of a client terminal in FIG. 1;

FIG. 6A is a flow chart illustrating a medical-image display process to be performed by the CPU in FIG. 5;

FIG. 6B is a flow chart illustrating the medical-image display process to be performed by the CPU in FIG. 5; and

FIG. 7 illustrates an example of a message dialogue menu.

### DESCRIPTION OF THE PREFERRED EMBODIMENTS

A medical-information management system and a computer-readable medium according to an embodiment of the present invention will be described below with reference to the accompanying drawings. The scope of the invention, however, should not be limited to the drawings.

### [Configuration of Medical-Information Management System 100]

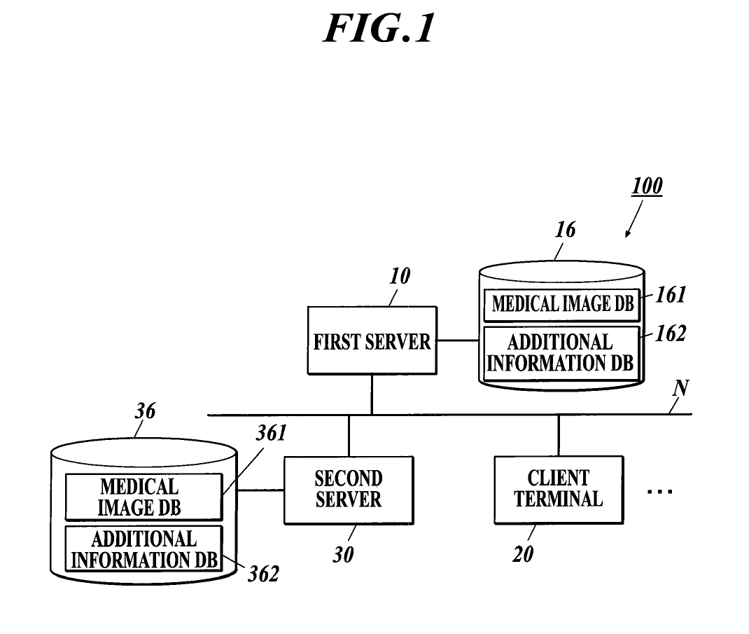

FIG. 1 illustrates a medical-information management system 100 according to this embodiment.

The medical-information management system 100 is installed in a hospital. The medical-information management system 100 includes a first server 10, a client terminal 20, and a second server 30 which are connected via a communication network N having communication lines, such as a local area network (LAN) or a wide area network (WAN) for data transmission and reception.

The devices included in the medical-information management system 100 and communication among the devices conform to the Digital Imaging and Communications in Medicine (DICOM) standard. The number of devices is not limited.

### [Configuration of First Server 10]

The first server 10 is a computer that stores and manages medical images generated at various modalities, such as CT devices, MRI devices, and CR devices; additional information associated with the medical images; and medical information, such as interpretation reports of the medical images. The first server 10 is a data management server manufactured by, for example, the same manufacturer of the client terminal 20 and serves as the main server in the medical-information management system 100.

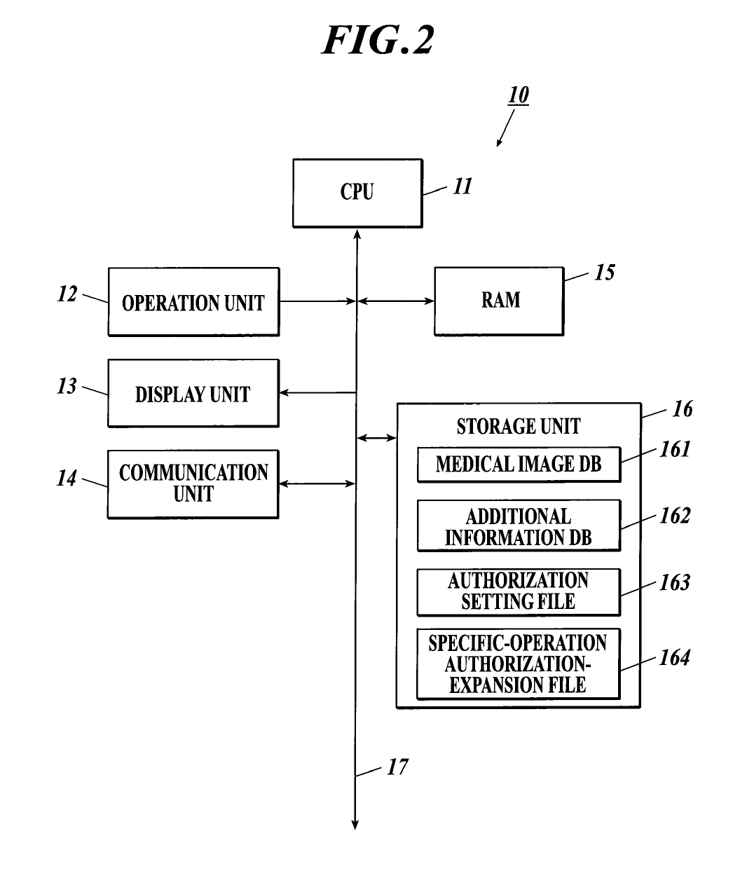

FIG. 2 illustrates the functional configuration of the first server 10.

The first server 10 includes a CPU 11, an operation unit 12, a display unit 13, a communication unit 14, a RAM 15, and a storage unit 16 which are connected to each other via a bus 17.

The CPU 11 reads out various programs stored in the storage unit 16, loads the readout programs in a work area in the RAM 15, and controls the units in the first server 10 in accordance with the programs.

The operation unit 12 includes a keyboard having, for example, cursor keys, numeric keys, and various function keys and a pointing device, such as a mouse. The operation unit 12 sends instruction signals input by operation of the keyboard and/or the mouse to the CPU 11.

The display unit 13 includes a monitor, such as a liquid crystal display (LCD) or a cathode ray tube (CRT), and displays various menus and medical images in accordance with instruction signals for display sent from the CPU 11.

The communication unit 14 includes a LAN adapter, a router, and a terminal adapter (TA) and transmits/receives data to/from the units connected via the communication network N.

The RAM 15 provides a work area where various programs read out from the storage unit 16, input and/or output data, and parameters are temporarily stored for various types of processing to be executed by the CPU 11.

The storage unit 16 includes a non-volatile memory, such as a hard disk drive (HDD) or semiconductor memory. The storage unit 16 stores the programs to be executed by the CPU 11 and data necessary for the run of programs the programs.

The storage unit 16 stores databases (DBs) (first storage unit), such as a medical image DB 161, which contains medical image data generated by modalities (not shown) and interpretation reports of the medical images; and an additional information DB 162, which contains searchable additional information associated with the medical images stored in the medical image DB 161.

Medical images are stored in the medical image DB 161 in a DICOM file format conforming to the DICOM standard. A DICOM file has an image region and a header region. The image region contains data of the actual medical image, and the header region contains additional information associated with the medical image. Additional information is input from a modality and includes patient information, examination information, series information, and image attribute information.

The patient information is associated with a patient who is a subject of the medical image and includes various items that identify the patient and are associated with the patient of the medical image, such as patient identification information (e.g., patient ID), patient name, sex, and date of birth.

The examination information is associated with an examination for the medical image and includes various items that identify the examination and are associated with the examination, such as examination identification information (e.g., examination ID), examination date, doctor in charge, type of modality (CT, MRI, CR, etc.), examined part, station name (device name (instrument name) of each modality), and examination description.

The series information includes various items such as a series number that identifies the series to which the medical image belongs, image type, and series description.

The image attribute information includes various items associated with the image, such as image identification information (e.g., image ID) for identifying the medical image, image number indicating the order of the medical image in the series (order of image acquisition), time of image generation, and file path name indicating the storage location of the medical image.

The storage unit 16 stores an authorization setting file 163 and a specific-operation authorization-extension file 164.

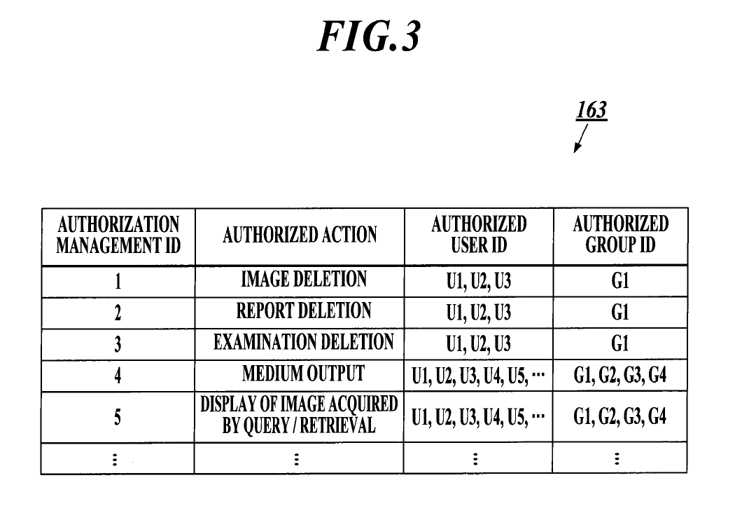

The authorization setting file 163 contains authorized-action information and the corresponding ID information of the authorized users and groups for the medical-information management system 100. The authorization setting file 163 contains items such as an authorization management ID, authorized action, authorized user ID, and authorized group ID, as illustrated in FIG. 3. In FIG. 3, reference characters U1 to U3 and G1 represent administrators (administrator groups) of the medical-information management system 100 and the other reference characters represent general users (e.g., doctor interpreting the medical image).

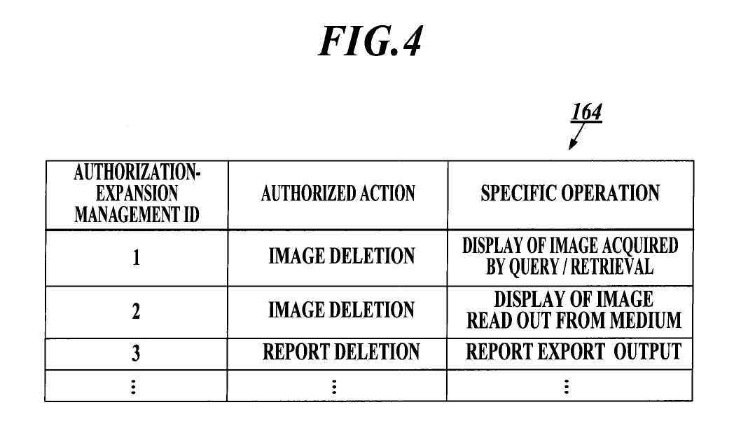

The specific-operation authorization-extension file 164 contains information on specific operations for which deletion authorization is expanded regardless of the setting of the authorization setting file 163, and contains corresponding information on the authorized action to be expanded in response to the specific operation. The specific-operation authorization-extension file 164 contains items such as authorization-expansion management ID, authorized action, and specific operation, as illustrated in FIG. 4.

The administrator may input setting information stored in the authorization setting file 163 and the specific-operation authorization-extension file 164 through the operation unit 12 or through an operation unit 22 of the client terminal 20.

The storage unit 16 stores user information (e.g., user ID and password) of users who can log in to the medical-information management system 100.

### [Configuration of Client Terminal 20]

The client terminal 20 is a terminal device, such as a personal computer (PC), that retrieves medical images and interpretation reports stored in the first server 10 or second server 30 and displays these for doctors to interpret the medical images.

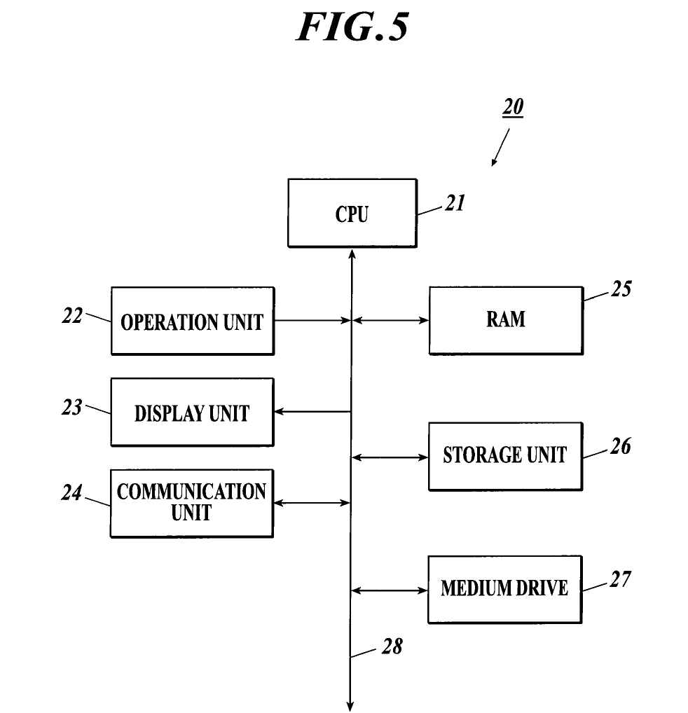

FIG. 5 illustrates the functional configuration of the client terminal 20.

The client terminal 20 includes a CPU 21, an operation unit 22, a display unit 23, a communication unit 24, a RAM 25, a storage unit 26, and a media drive 27 which are connected to each other via a bus 28.

The CPU 21 reads out various programs stored in the storage unit 26, loads the readout programs in a work area in the RAM 25, and controls the units in accordance with the programs.

The operation unit 22 includes a keyboard having, for example, cursor keys, numeric keys, and various function keys and a pointing device, such as a mouse. The operation unit 22 sends instruction signals input by operation of the keyboard and/or the mouse to the CPU 21.

The display unit 23 includes a monitor, such as a liquid crystal display (LCD) or a cathode ray tube (CRT), and displays various menus and medical images in accordance with instruction signals for display sent from the CPU 21.

The communication unit 24 includes a LAN adapter, a router, and a terminal adapter (TA) and transmits/receives data to/from the units connected via a communication network N.

The RAM 25 provides a work area where various programs read out from the storage unit 26, input and/or output data, and parameters are temporarily stored for various types of processing to be executed by the CPU 21.

The storage unit 26 includes a non-volatile memory, such as a hard disk drive (HDD) or a semiconductor. The storage unit 26 stores various programs to be executed by the CPU 21, data necessary for the run of the programs, and various types of setting information. The programs are stored in the storage unit 26 in the form of computer-readable program codes. The CPU 21 sequentially carries out operation in accordance with the program codes.

The media drive 27 (reader) reads out data of medical images and interpretation reports recorded in a recoding medium, such as a compact disk recordable (CD-R) or a digital versatile disk recordable (DVD-R), and outputs the readout data to the CPU 21.

### [Configuration of Second Server 30]

The second server 30 is a computer that stores and manages medical images generated by various modalities, such as CT devices, MRI devices, and CR devices; additional information associated with the medical images; and interpretation reports of the medical images. Similar to the first server 10, which is illustrated in FIG. 2, the second server 30 also includes a CPU, an operation unit, a display unit, a communication unit, a RAM, and a storage unit. Similar to the first server 10, the storage unit stores a medical image DB 361 and additional information DB 362 (second storage unit).

The second server 30 is an external server manufactured by, for example, a manufacturer different from that of the first server 10 and the client terminal 20. A medical image in the second server 30 is retrieved to be displayed on the client terminal 20 via the first server 10 using Query/Retrieve Service Class User, which is a service conforming to the DICOM standard.

### [Operation of Medical-Information Management System 100]

The operation of the medical-information management system 100 will be described below.

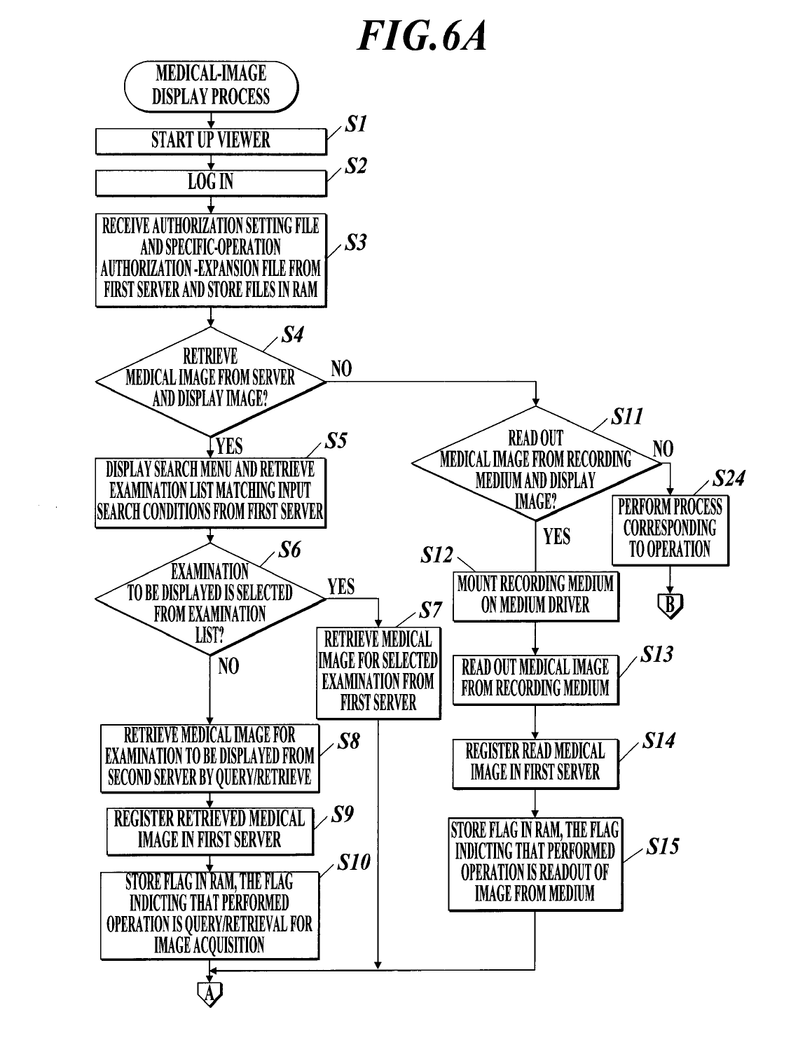

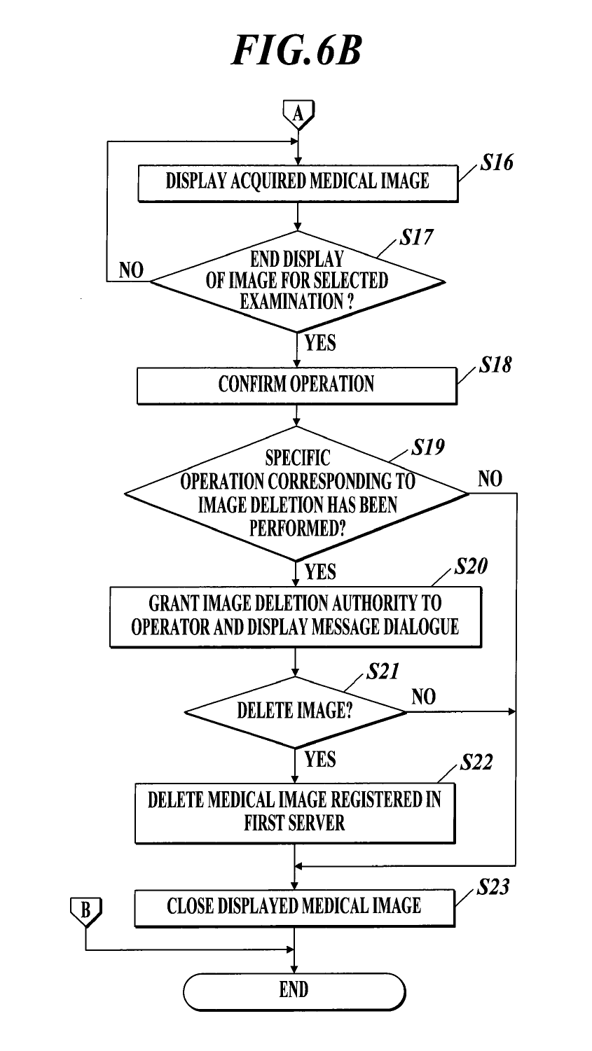

FIGS. 6A and 6B illustrate the flow of a medical-image display process to be performed by the client terminal 20. The medical-image display process is performed with the CPU 21 and programs stored in the storage unit 26 working in cooperation with each other.

Operation of the operation unit 22 of the client terminal 20 starts up a viewer (which is a program for displaying medical images and interpretation reports using the functions of the medical-information management system 100) (Step S1), and then, a log-in process is performed (Step S2). Specifically, a log-in menu for the medical-information management system 100 is displayed on the display unit 23, and then, the user ID and password input to the log-in menu through the operation unit 22 are sent to the first server 10 by the communication unit 24. The first server 10 authenticates log-in on the basis of the received user ID and password. Upon log-in authentication, the authorization setting file 163, the specific-operation authorization-extension file 164, and the group ID of the log-in user are read out from the storage unit 16 and sent to the client terminal 20 by the communication unit 14.

After the log-in process, the authorization setting file 163 and the specific-operation authorization-extension file 164 are sent from the first server 10 to the communication unit 24 and stored in the RAM 25 (Step S3). The client terminal 20 displays menus based on the user ID and group ID of the log-in user and based on the authorization setting file 163, so that only processes authorized to the log-in user can be performed. For example, an operation menu for instructing execution of a process not authorized to the user is not displayed. Alternatively, for example, an operation button for instructing execution of a process not authorized to the user is displayed in gray and invalid.

Then, it is determined whether retrieving medical images from a server and displaying the images is instructed through the operation unit 22 (Step S4). If it is determined that retrieving medical images from the server and displaying the images is instructed through the operation unit 22 (YES in Step S4), a search menu (not shown) is displayed on the display unit 23, and a list of examinations that match the search conditions input to the search menu through the operation unit 22 is received from the first server 10 (Step S5). Search conditions may include AND/OR conditions on examination ID, examination date, examination part, patient ID, patient name, department, and doctor in charge. The first server 10 searches the additional information DB 162 in accordance with the received search conditions and sends the retrieved examination list to the client terminal 20. That is, the examination list sent from the first server 10 contains only examinations associated with the medical images stored in the medical image DB 161 of the first server 10.

The examination list sent from the first server 10 is then displayed on the display unit 23, and it is determined whether an examination to be displayed is selected through the operation unit 22 (Step S6).

If it is determined that an examination to be displayed is selected from the examination list displayed on the display unit 23 through the operation unit 22 (YES in Step S6), medical images associated with the selected examination are retrieved from the first server 10 (Step S7), and the process skips to Step S16.

If an examination to be displayed is not selected from the examination list displayed on the display unit 23 through the operation unit 22 (i.e., if medical images associated with the examination to be displayed are not stored in the first server 10) and if image retrieval by the Query/Retrieve process is instructed (NO in Step S6), medical images associated with the examination to be displayed are retrieved from the second server 30 by the Query/Retrieve process in accordance with the operation of the operation unit 22 (Step S8).

Specifically, in Step S8, first, a search menu for image retrieval by the Query/Retrieve process (Query/Retrieve search menu) is displayed on the display unit 23. In response to input of search conditions through the Query/Retrieve search menu, the communication unit 24 makes an inquiry for examinations that match the search conditions to the second server 30 via the first server 10. The second server 30 searches the additional information DB 362 in accordance with the search conditions of the inquiry and sends the retrieved examination list to the client terminal 20 via the first server 10. The communication unit 24 of the client terminal 20 receives the examination list and displays the received examination list on the display unit 23. In response to selection of an examination to be displayed from the displayed examination list through the operation unit 22, the communication unit 24 sends a request for retrieving medical images associated with the selected examination via the first server 10 to the second server 30. The requested medical images associated with the examination are read out from the medical image DB 361 of the second server 30 and are sent to the client terminal 20 via the first server 10. The communication unit 24 of the client terminal 20 receives the medical images from the second server 30.

The medical images to be displayed are sent from the second server 30 by the Query/Retrieve process and are registered in the databases (medical image DB 161 and additional information DB 162) in the first server 10 via the communication unit 24 (Step S9). Then, a flag is stored in the RAM 25 to indicate that the operation that has been performed is retrieval of images by the Query/Retrieve process (Step S10), and the process proceeds to Step S16. As the flag, a numeral of the authorization-expansion management ID corresponding to the performed operation may be used, for example (see FIG. 4).

In Step S4, if it is determined that retrieving medical images from the server and displaying the images is not instructed but determined that reading out medical images from a medium and displaying the images is instructed through the operation unit 22 (NO in Step S4 and YES in Step S11), the media drive 27 waits for a recording medium to be mounted thereon. When a recoding medium is mounted on the media drive 27 (Step S12), the media drive 27 reads out data on medical images stored in the recording medium in response to the operation of the operation unit 22 (Step S13).

If medical images are acquired from the recording medium, the medical images acquired from the recording medium by the media drive 27 are registers in the databases (medical image DB 161 and additional information DB 162) in the first server 10 via the communication unit 24 (Step S14). Then, a flag is stored in the RAM 25 to indicate that the operation that has been performed is medium readout (Step S15), and the process proceeds to Step S16.

In Step S16, the medical image acquired from the first server 10, the second server 30, or the recording medium is displayed on a viewer screen on the display unit 23 (Step S16). The user or doctor interpreting the medical images examines and interprets the medical images on the viewer screen.

When quitting of the display of the image for the selected examination is instructed through the operation unit 22 (YES in Step S17), the RAM 25 and the specific-operation authorization-extension file 164 are referred to to confirm the operation that has been performed (Step S18). The quitting of the display of an examination may be instructed, for example, by operation of searching for next examination from the examination list, closing the displayed viewer screen, or clicking the “quit interpretation” button appearing on the viewer screen.

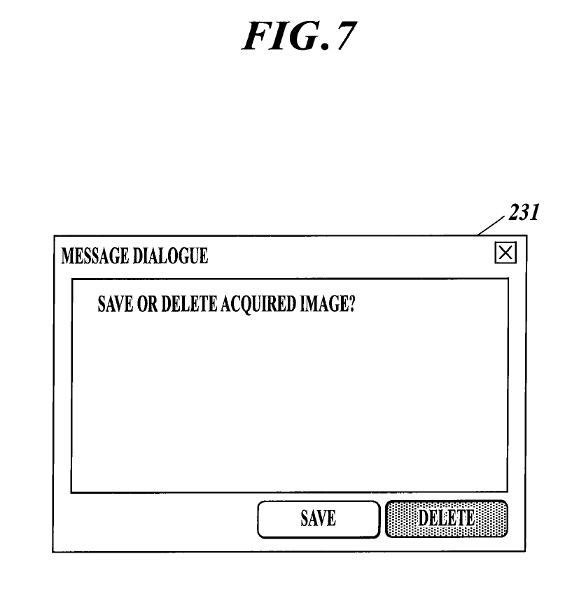

If it is determined, as a result of confirming the operation that has been performed, that a specific operation corresponding to the image deletion authority has been performed (YES in Step S19), the current user (operator) operating the operation unit 22 is granted (expanded) the authority to delete the medical images used in the specific operation (here, the medical images are those associated with the examination being displayed), and a message dialogue menu 231 (see FIG. 7), which inquires the user whether the medical images used in the specific operation are to be deleted (discarded) from the database of the first server 10, is displayed on the display unit 23 (Step S20). Then, the process waits for an input to the message dialogue menu 231. If the deletion (discard) of the medical images used in the specific operation is instructed through the operation unit 22 (YES in Step S21), the medical images registered in the databases of the first server 10 in Step S9 or S14 are deleted from the database of the first server 10 (Step S22), and the process proceeds to Step S23. Specifically, the communication unit 24 sends information (image ID, etc.), which specifies the medical images registered in the database of the first server 10 in Step S9 or S14, and the request for deleting the medical images to the first server 10; and the medical images and the additional information corresponding to the image IDs received by the first server 10 are deleted from the databases (medical image DB 161 and additional information DB 162).

In Step S19, if it is determined that a specific operation corresponding to image deletion is not performed or if an instruction for not deleting the medical images used in the specific operation is inputted (NO in Step S19 and NO in Step S21), the process skips to Step S23.

In Step S23, the medical images associated with the examination displayed on the display unit 23 are closed (Step S23), and the medical-image display process ends.

In Step S11, if it is determined that reading out medical images from a medium and displaying the images is not instructed through the operation unit 22 (NO in Step S11), a process corresponding to the operation of the operation unit 22 is performed (Step S24), and the process ends.

As described above, the CPU 21 of the client terminal 20 in the medical-information management system 100 determines whether a specific operation is performed through the operation unit 22, wherein the specific operation includes (a) acquiring medical images from a recording unit or medium other than the database of the first server 10, for example, from the database of the second server 30 or a recording medium; (b) registering the medical images in the medical image DB 161; and (c) displaying the medical images registered in the medical image DB 161 on the display unit 23. When the CPU 21 determines that the specific operation is performed, the CPU 21 grants an operator of the operation unit 22 authority to delete the medical images, acquired in the specific operation, from the database of the first server 10.

Therefore, a user, who normally is not authorized to delete medical images, can retrieve medical images from the second server 30 or the recording medium; interpret the medical images using the viewer function of the medical-information management system 100; and delete data on the medical images that is stored in the second server 30 or the recording medium and does not need to be kept in the first server 10, from the first server 10 after the medical images are interpreted. Hence, the storage capacity of the first server 10 is not consumed by data not required to be kept in the first server 10.

Further, it is not necessary to change a setting every time a user who is not authorized to delete medical images is to delete a medical image. This eliminates the need for complicated processes to expand image deletion authority to users who have performed specific operations. Moreover, a user who has performed a specific operation is authorized to delete only medical images that are associated with the specific operation only at a time when the specific operation is completed. Thus, the medical images to be stored in the first server 10 are prevented from being deleted by an unauthorized user.

The embodiment described above is merely a preferred example of the present invention, and the present invention is not limited thereto.

For example, in the medical-image display process illustrated in FIGS. 6A and 6B, display of images acquired by the Query/Retrieve process and display of images read out from a medium (i.e., reading out medical images from a recording medium and displaying the readout medical images) are defined as specific operations, but the process is not limited thereto. For example, the specific operation may be report export output. In this case, when an operator exports a report from the first server 10 to the second server 30, the operator may be authorized to delete the report from the first server 10. Alternatively, the specific operation may be acquisition and display of interpretation reports by the Query/Retrieve process from any other server or may be readout and display of interpretation reports from a recording medium.

In the medical-image display process illustrated in FIGS. 6A and 6B, the client terminal 20 determines whether a specific operation is performed and whether to expand authority (whether to authorize deletion). Alternatively, the first server 10 may determine whether a specific operation is performed and whether to expand the authority. In such a case, for example, Step S3 is skipped, and flags are stored in the RAM 15 of the first server 10 in Steps S10 and S15. In Step S18, when the client terminal 20 sends a request to the first server 10 to confirm the operation that has been performed, Steps S19 to S22, i.e., the step of making judgment about the specific operation to the step of deleting medical images, are performed in the first server 10, and a notice of deletion completion is sent to the client terminal 20. Upon reception of the notice of deletion completion, the client terminal 20 closes the medical images associated with the examination displayed on the display unit 23.

The medical information, for which the authority of deletion is to be expanded after the specific operation, is not limited to medical images and interpretation reports, and may be specimen examination data or any other medical information.

The first server 10 stores the authorization setting file 163 and the specific-operation authorization-expansion file 164. Instead, the client terminal 20 may store the files.

The medical-information management system according to the above-described embodiment includes the first server 10 and the client terminal 20, which are independent units. Alternatively, a medical-information management system may include a single computer that functions as both the first server 10 and the client terminal 20. In such a case, programs for implementing the control functions of the present invention are stored in a storage unit of the computer, and the present invention is achieved with a CPU and the programs working in cooperation with each other.

In the above-described embodiment, a non-volatile memory, such as a hard disk or a semiconductor memory, is used as a computer-readable medium storing the programs according to the present invention. However, the medium is not limited thereto. Examples of other computer-readable media include portable recording media, such as a CD-ROM. A carrier wave can also be used as a medium providing data containing the programs according to the present invention via a communication line.

Detailed configurations and operations of the devices in the medical-information management system may be appropriately modified without departing from the scope of the present invention.

According to a first aspect of the preferred embodiments of the present invention, there is provided a medical-information management system including: an operation unit; a first storage unit that stores medical information; a display unit; and a control unit that determines whether an operation is performed through the operation unit, the operation including (a) acquiring the medical information from one of a second storage unit and a recording medium, (b) storing the acquired medical information in the first storage unit, and (c) displaying the medical information stored in the first storage unit on the display unit; and that grants an operator of the operation unit authority to delete the medical information, acquired in the operation, from the first storage unit when it is determined that the operation is performed.

According to the present invention, the storage capacity of a server is prevented from being consumed by medical data that is not need to be kept in the server.

Preferably, the medical-information management system further includes: a first server that includes the first storage unit; and a second server that includes the second storage unit, wherein when the control unit determines that the operation is performed through the operation unit, the operation including (a) acquiring the medical information from the second storage unit, (b) storing the acquired medical information in the first storage unit, and (c) displaying the medical information stored in the first storage unit on the display unit; the control unit grants the operator of the operation unit the authority to delete the medical information, acquired from the second storage unit in the operation, from the first storage unit.

Preferably, the medical-information management system further includes a reader that reads out the medical information recorded in the recording medium, wherein when the control unit determines that the operation is performed through the operation unit, the operation including (a) reading out the medical information from the recording medium through the reader, (b) storing the read medical information in the first storage unit, and (c) displaying the medical information stored in the first storage unit on the display unit; the control unit grants the operator of the operation unit the authority to delete the medical information, read out from the recording medium in the operation, from the first storage unit.

Preferably, the medical information includes a medical image.

According to a second aspect of the preferred embodiments of the present invention, there is provided a non-transitory computer-readable medium that stores a program to control a computer used for a medical-information management system, the system including an operation unit, a first storage unit that stores medical information, and a display unit; wherein the program controls the computer to function as a control unit that determines whether an operation is performed through the operation unit, the operation including (a) acquiring the medical information from one of a second storage unit and a recording medium, (b) storing the acquired medical information in the first storage unit, and (c) displaying the medical information stored in the first storage unit on the display unit; and that grants an operator of the operation unit authority to delete the medical information, acquired in the operation, from the first storage unit when it is determined that the operation is performed.

The entire disclosure of Japanese Patent Application No. 2011-058787 filed on Mar. 17, 2011 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A medical-information management system comprising:
an operation unit;
a first storage unit that stores medical information;
a display unit; and
a control unit that determines whether an operation is performed through the operation unit, the operation including (a) acquiring the medical information from one of a second storage unit and a recording medium, (b) storing the acquired medical information in the first storage unit, and (c) displaying the medical information stored in the first storage unit on the display unit; and that grants an operator of the operation unit authority to delete the medical information, acquired in the operation, from the first storage unit when it is determined that the operation is performed.

2. The medical-information management system according to claim 1, further comprising:
a first server that includes the first storage unit; and
a second server that includes the second storage unit, wherein
when the control unit determines that the operation is performed through the operation unit, the operation including (a) acquiring the medical information from the second storage unit, (b) storing the acquired medical information in the first storage unit, and (c) displaying the medical information stored in the first storage unit on the display unit; the control unit grants the operator of the operation unit the authority to delete the medical information, acquired from the second storage unit in the operation, from the first storage unit.

3. The medical-information management system according to claim 1, further comprising a reader that reads out the medical information recorded in the recording medium, wherein
when the control unit determines that the operation is performed through the operation unit, the operation including (a) reading out the medical information from the recording medium through the reader, (b) storing the read medical information in the first storage unit, and (c) displaying the medical information stored in the first storage unit on the display unit; the control unit grants the operator of the operation unit the authority to delete the medical information, read out from the recording medium in the operation, from the first storage unit.

4. The medical-information management system according to claim 1, wherein the medical information includes a medical image.

5. A non-transitory computer-readable medium that stores a program to control a computer used for a medical-information management system, the system comprising an operation unit, a first storage unit that stores medical information, and a display unit; wherein the program controls the computer to function as a control unit that determines whether an operation is performed through the operation unit, the operation including (a) acquiring the medical information from one of a second storage unit and a recording medium, (b) storing the acquired medical information in the first storage unit, and (c) displaying the medical information stored in the first storage unit on the display unit; and that grants an operator of the operation unit authority to delete the medical information, acquired in the operation, from the first storage unit when it is determined that the operation is performed.
